(19) United States
(12) Patent Application Publication
(10) Pub. No.: US 2008/0017423 A1
(43) Pub. Date: Jan. 24, 2008

(54) Fuel saver machine

(76) Inventor: Leonardo M. Gasendo, Camarillo, CA (US)

Correspondence Address: LEONARDO M. GASENDO, 11238 LEISURE VILLAGE II, CAMARILLO, CA, 93012, US

(21) Appl. No.: 11/490,454

(22) Filed: Jul. 21, 2006

(51) Int. Cl. B60K 16/00

(52) U.S. Cl. 180/2.2

(57) ABSTRACT

A fuel saver machine is fixedly secured to a hybrid vehicle in order to produce the air resistance force which is a homogeneous, compressible fluid with thermodynamic power densities that increase exponentially during acceleration. The fuel saver machine is using the available air resistance force to produce large amounts of electricity during transit. The total amount of electricity produced by the fuel saver machine will save the equivalent gallons of fossil fuel for the hybrid vehicle per hour of travel time. At optimum cruising speed the fuel saver machine will produce nearly all the energy needs of the hybrid vehicle with little fossil fuel consumption. At optimum cruising speed going downhill the pull of gravity will help the fuel saver machine to produce excess electricity with no fossil fuel consumption. The excess electricity is stored in the power battery of the hybrid vehicle as reserve power for the uphill climb.

### REFERENCE CITED

U.S. PATENT DOCUMENTS

| U.S. Document No. | Publication Date | Patentee |
|---|---|---|
| 4,127,356 | Nov. 28, 1978 | Murphy |
| 4,191,505 | Mar. 4, 1980 | Kaufman |

### BACKGROUND OF THE PRESENT INVENTION

The soaring gas prices has ushered the commercial production of the hybrid vehicle which consumes fossil fuel and electricity from the power battery that is fully charged overnight through the household electrical outlet. The fossil fuel and household electricity are both expensive commodities. During transit the hybrid vehicle is consuming a lot of fossil fuel just to overcome the air resistance force that is pushing the hybrid vehicle to the opposite direction. The air resistance force is a homogeneous, compressible fluid with thermodynamic power densities that increase exponentially, releasing large amounts of heat during acceleration. For example the power densities of the air resistance force at different cruising speed are approximately as follows: 13,000 watts per square meter at 50 miles per hour cruising speed, 23,000 watts per square meter at 60 miles per hour cruising speed, and 44,000 watts per square meter at 75 miles per hour cruising speed. Just recently the air resistance force totally destroyed the NASA space shuttle during reentry into the earth's atmosphere. For economic reasons it is necessary to provide a lightweight fuel saver machine that will use the air resistance force to produce electricity and save a significant amount of fossil fuel for the hybrid vehicle during transit.

The prior art machines do not have the capabilities to handle the high power densities of the air resistance force because they have too many moving parts that create negative back-flows, too many loopholes for escape, and they depend on the ambient wind velocity and wind direction to produce electricity. The U.S. Pat. Nos. 4,191,505 and 4,127,356 have low electricity generation capacity due to numerous design deficiencies.

### OBJECT OF THE PRESENT INVENTION

It is the object of the present invention to provide a lightweight fuel saver machine that will use the available air resistance force to produce electricity and save a significant amount of fossil fuel for the hybrid vehicle during transit.

The other objects of the present invention will be clearly seen in the following drawings and description.

### BRIEF DESCRIPTION OF THE DRAWINGS

FIG. 1 is the side view of the fuel saver machine mounted on a hybrid vehicle (in phantom).

FIG. 2 is the isometric view of the fuel saver machine showing the housing and the rotor assembly.

FIG. 3 is the isometric view of the housing showing the two sides, an inlet opening, an exit opening, a curved wall, a nose shaped wall, an inlet baffle, and an exit baffle.

FIG. 4 is the isometric view of the rotor assembly showing a pair of bearings, a plurality of blades, a pair of hubs, a pulley and the central opening.

FIG. 5 is the isometric view of the shaft showing a pair of hubs, a pair of bearings, a drive pulley, a drive belt, and an electric generator.

FIG. 6 is the isometric view of the blade showing the longitudinal fins.

FIG. 7 is the side view of the blade showing the longitudinal fins.

FIG. 8 is the front view of the fuel saver machine showing the housing and the rotor assembly.

FIG. 9 is the cross sectional view of the fuel saver machine taken along the lines 27 and 27 of FIG. 8.

### DETAILED DESCRIPTION OF THE DRAWINGS

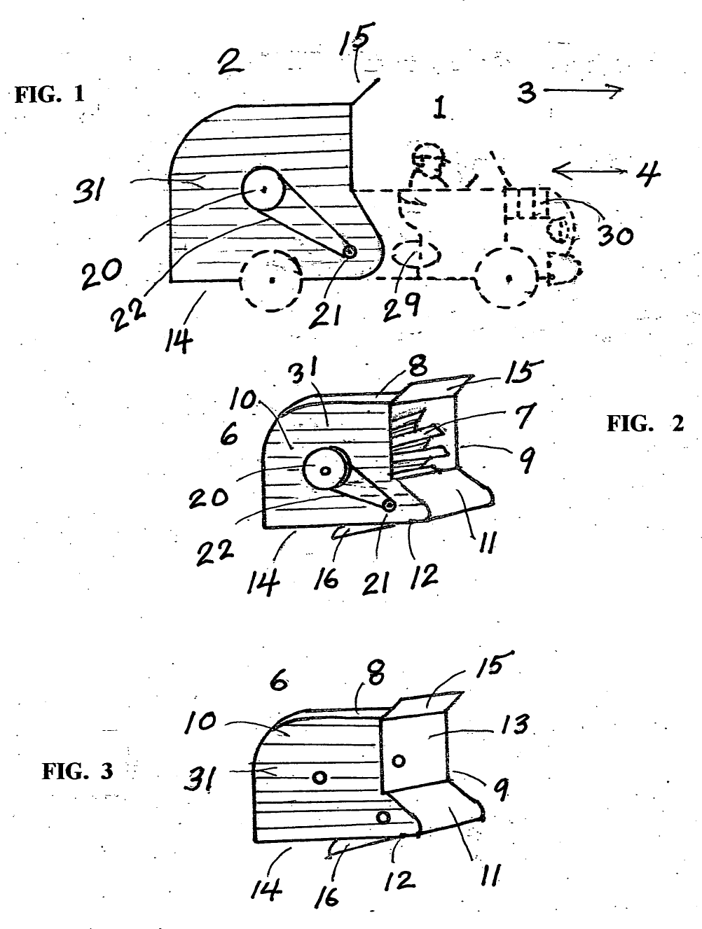

In FIG. 1 the fuel saver machine 2 is fixedly secured to the hybrid vehicle 1 (in phantom) in order to produce the air resistance force 4 that is used by the fuel saver machine 2 to produce large amounts of electricity during transit. The air resistance force 4 is a homogeneous, compressible fluid that is difficult to control using ordinary tools and procedures. The fuel saver machine 2 is provided with the proper tools to control the air resistance force 4 for the production of large amounts of electricity without depending on the ambient wind velocity and wind direction.

As seen in FIG. 2 the fuel saver machine 2 comprises, a housing 6 and a rotor assembly 7 which is rotatably disposed inside housing 6. In FIG. 3 the housing 6 includes an inlet opening 13, an exit opening 14, a curved wall 8 that extends rearwardly from the inlet opening 13 to the exit opening 14, a pair of vertical walls 9 and 10, a nose shaped wall 11 with a floor 12, an inlet baffle 15, an exit baffle 16 and a plurality of fins 31 that are rigidly affixed to the external walls of housing 6. The inlet baffle 15 is fixedly secured to the curved cover 8 at the inlet opening 13 and extends forwardly, upwardly at a 45 degree angle of a horizontal plane. The exit baffle 16 is fixedly secured to the floor 12 at the exit opening 14 and extends rearwardly, outwardly of housing 6.

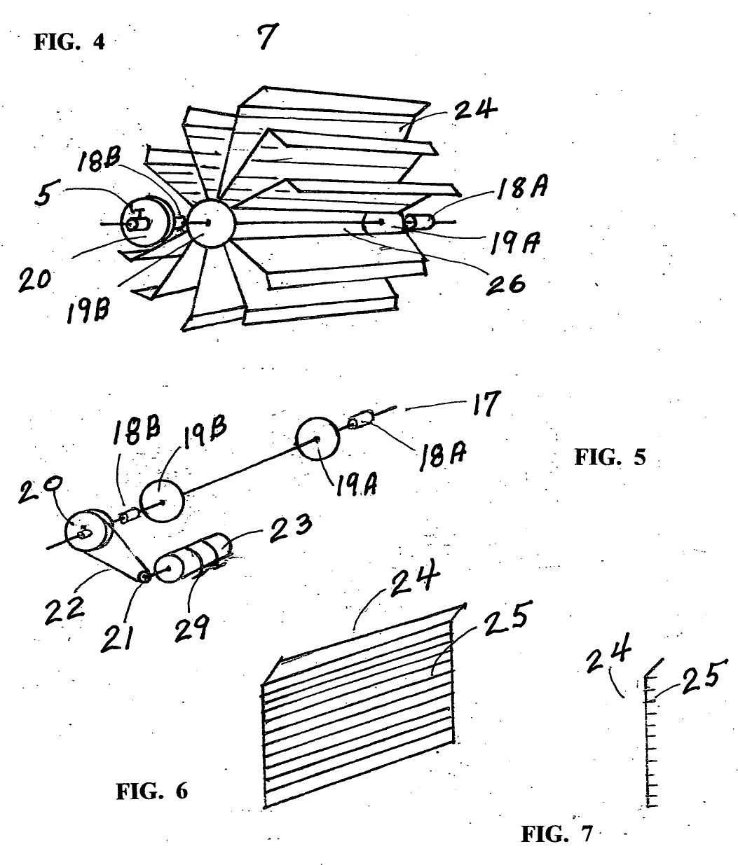

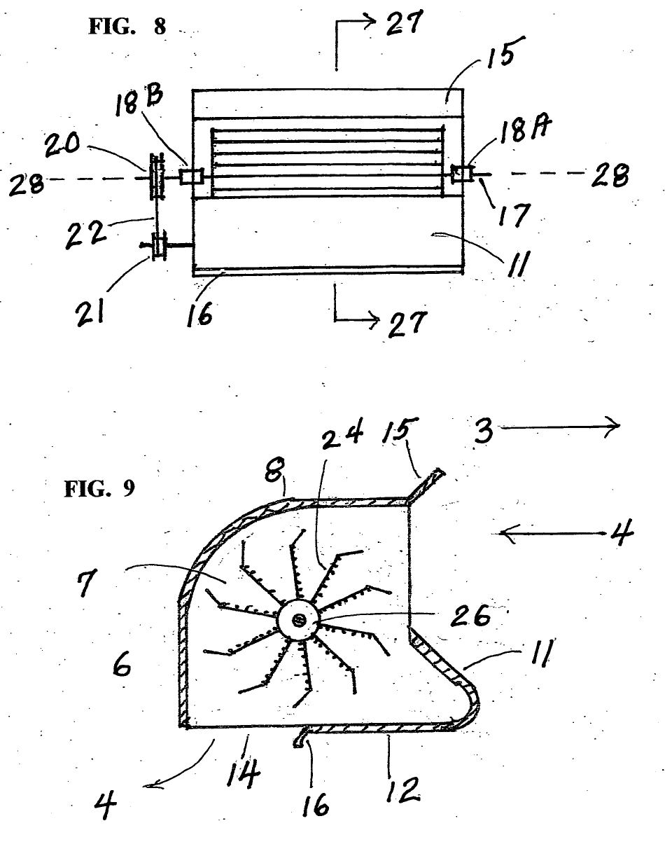

In FIGS. 4, 5, 6 and 7 the rotor assembly 7 includes a shaft 17, a pair of hubs 19A and 19B, a pair of bearings 18A and 18B, a drive belt 22, an electric generator 23, a central opening 26, a plurality of blades 24 that are evenly, radially and fixedly secured to the hubs 19A and 19B and a plurality of fins 25 that are longitudinally and rigidly affixed to the impact surface of blades 24. In FIG. 2 the electric generator 23 is rigidly affixed to the floor 12. The drive belt 22 is rotatably engaged with the pulley 20 and the pulley 21 of the electric generator 23. The rotor assembly 7 is built of strong composite materials that are commonly used in the aerospace industry. The fins 25 provide more area to the impact surface of blades 24 for extracting more energy from the air resistance force 4. The blades 24 have the capacity to supply all the energy needs of the hybrid vehicle 1 (in phantom) including the capacity to extract the additional excess energy that is available at optimum cruising speed.

In FIG. 9, the air resistance force 4 is compressed and directed by the inlet baffle 15 into the housing 6. The housing 6 captures the air resistance force 4 in volumetric form for a considerable length of time with minimum wastage from the inlet opening 13 to the exit opening 14. The curved wall 8 compresses and directs the air resistance force 4 to continue impinging upon the retreating rear blades 24. A portion of the fresh air resistance force 4 is allowed passage through the central opening 26 of the rotor assembly 7 to impinge upon and deliver more rotational force to the retreating rear blades 24. There is turbulent flow of the air resistance force 4 inside housing 6 as the rotor assembly 7 extracts large amounts of energy from the air resistance force 4 thereby releasing large amounts of heat due to friction, compression and electricity generation inside the housing 6. The heat is immediately removed from the housing 6 and transferred to the outside air by the fins 31 otherwise the electricity production efficiency of the electric generator 23 will go down significantly under high temperature conditions. Therefore the housing 6 is at the same time functioning as a heat exchanger for cooling down the air resistance force 4 during operation. During transit the exit baffle 16 creates a low pressure condition at the exit 14 thus creating a high differential pressure across the housing 6 which enhances more flow of the air resistance force 4 through the housing 6.

At optimum cruising speed the fuel saver machine 2 will produce nearly all the energy needs of the hybrid vehicle 1 (in phantom) resulting in little fossil fuel consumption. At optimum cruising speed going downhill the pull of gravity will help the fuel saver machine 2 to produce excess electricity with no fossil fuel consumption. The excess electricity is stored in the battery 30 (in phantom) as reserve power for the uphill climb. The total amount of electricity that is produced by the fuel saver machine 2 will save the equivalent gallons of fossil fuel for the hybrid vehicle 1 (in phantom) per hour of travel time so much so that the trip from New York to Los Angeles will save hundreds of gallons of fossil fuel worth hundreds of dollars based on the price of fossil fuel at the filling station today. For more fossil fuel savings, a plurality of fuel saver machine 2 may be installed rearwardly as seen in FIG. 1, on top and forwardly of the hybrid vehicle 1. The fuel saver machine 2 may also be installed on other hybrid vehicles that are traveling on land, air and water.

The features and combinations illustrated and described herein represent a more advance concepts in fuel saver machine design and they are significant elements of the present invention. These include all alternatives and equivalents within the broadest scope of each claim as understood in the light of the prior art.

I claim:

1. A fuel saver machine comprising a housing and a rotor assembly wherein said housing includes an inlet opening, an exit opening, a pair of vertical walls, a curved wall, a nose shaped wall with a floor, an inlet baffle, an exit baffle and a plurality of fins that are rigidly affixed to the exterior walls of said housing and wherein said rotor assembly includes a shaft, a pair of hubs, a pair of bearings, a pair of pulleys, a drive belt, a central opening, an electric generator, a plurality of blades that are evenly, radially and fixedly secured to said hubs and a plurality of fins that are longitudinally and rigidly affixed to the impact surface of said blades.

2. The invention as defined in claim 1 wherein said fuel saver machine is using the available homogeneous, compressible air resistance force with thermodynamic power densities that increase exponentially, releasing large amounts of heat during acceleration for the production of large amounts of electricity without depending on the ambient wind velocity and wind direction.

3. The invention as defined in claim 1 wherein said inlet baffle is disposed to compress and direct said air resistance force into said housing wherein said air resistance force impinges upon said blades for a considerable length of time from said inlet opening to said exit opening thereby enabling said rotor assembly to extract more energy from said air resistance force to produce more electricity.

4. The invention as defined in claim 1 wherein said exit baffle creates a low pressure condition at said exit opening and the resulting high differential pressure across said housing enhances more flow of said air resistance force through said housing.

5. The invention as defined in claim 1 wherein said housing captures said air resistance force in volumetric form thereby enabling said rotor assembly to extract large amounts of energy from said air resistance force and the resulting large amounts of heat that is released inside said housing is immediately removed and transferred by said exterior fins of said housing to the outside air thereby enabling said housing to function at the same time as a heat exchanger otherwise the electricity production efficiency of said electric generator will go down significantly under high temperature conditions.

6. The invention as defined in claim 1 wherein said longitudinal fins on said blades provides more areas of said blades to extract more energy from said air resistance force thus producing more electricity.

7. The invention as defined in claim wherein said central opening of said rotor assembly allows passage of said air resistance force to impinge upon said retreating rear blades.

8. The invention as defined in claim 1 wherein said rotor assembly is rotatably disposed inside said housing wherein said rotor assembly is using said blades for extracting large amounts of energy from said air resistance force to produce electricity wherein the total amount of electricity produced by said electric generator will save the equivalent gallons of fossil fuel per hour of travel time.

9. The invention as defined in claim 1 wherein at optimum cruising speed said fuel saver machine will produce nearly all the energy needs of said hybrid vehicle (in phantom) with little fossil fuel consumption and wherein at optimum cruising speed going downhill the force of gravity will help said fuel saver machine to produce excess electricity with no fossil fuel consumption during transit.
